(19) United States
(12) Patent Application Publication
(10) Pub. No.: US 2025/0240394 A1
(43) Pub. Date: Jul. 24, 2025

(54) CHROMAKEY SCREEN SYSTEM

(71) Applicants: Ho Kyoung KIM, Seoul (KR); Seong-Hwa KIM, Gyeonggi-do (KR); Seung Hyun SON, Gyeonggi-do (KR)

(72) Inventors: Ho Kyoung KIM, Seoul (KR); Seong-Hwa KIM, Gyeonggi-do (KR); Seung Hyun SON, Gyeonggi-do (KR)

(21) Appl. No.: 18/631,169

(22) Filed: Apr. 10, 2024

(30) Foreign Application Priority Data
Jan. 24, 2024 (KR) 10-2024-0010917

(51) Int. Cl. H04N 9/75

(52) U.S. Cl. CPC H04N 9/75

(57) ABSTRACT

An embodiment discloses a chromakey screen system including a plurality of chromakey screen units connected with each other, each including a frame, a screen attached to the front of the frame, and fastening devices mounted on the frame, wherein the frames of the chromakey screen units are interconnected in a grid pattern via the fastening devices, with the screens of the chromakey screen units abutting along the edges to form a single integrated screen, and the shape of the integrated screen is configured to be variable according to the arrangement structure of the chromakey screen units forming the grid pattern.

### CROSS REFERENCE TO RELATED APPLICATION

The present application claims priority to Korean Patent Application No. 10-2024-0010917, filed on Jan. 24, 2024, in the Korean Intellectual Property Office, the disclosure of which is incorporated herein by reference in its entirety for all purposes.

### FIELD AND BACKGROUND OF THE INVENTION

### Field

The present invention relates to a chromakey screen system, and more particularly, to a chromakey screen system having an assembly-variable structure.

### Description of the Related Art

Chromakey technology is generally used in VFX and CG video production for movies, dramas, and broadcasting, as well as in the implementation of augmented reality (AR) that combines virtual objects or information with reality in real time. With the advancement of over-the-top (OTT) platforms (Netflix and Disney, etc.), chromakey technology is being adopted and used more actively as a core technology for capturing various CG scenes that cannot be resolved with new filming techniques such as extended reality (XR).

However, the chromakey method presents a drawback of demanding significant time, expense, and labor for setup, which entails a large fabric screen with a uniform single-color background extensively stretched to differentiate the subjects being filmed from the background.

In particular, it is challenging to install the screen to fit the designed structure, covering a wide area, and there are environmental concerns regarding the generation of industrial waste from disposing of large quantities of screen fabric and wood after use. Therefore, there is a need for improvement in this regard.

### SUMMARY OF THE INVENTION

The present invention has been conceived to solve the above problem and aims to provide a chromakey screen system capable of being used semi-permanently even in adverse weather conditions such as wind and rain at the filming location, without generating industrial waste, as opposed to disposable products made of fabric and wood.

The objects of the present invention are not limited to the aforesaid, and other objects not described herein with will be clearly understood by those skilled in the art from the descriptions below.

A chromakey screen system according to an embodiment of the present invention includes a plurality of chromakey screen units connected with each other, each including a frame, a screen attached to the front of the frame, and fastening devices mounted on the frame, wherein the frames of the chromakey screen units are interconnected in a grid pattern via the fastening devices, with the screens of the chromakey screen units abutting along the edges to form a single integrated screen, and the shape of the integrated screen is configured to be variable according to the arrangement structure of the chromakey screen units forming the grid pattern.

The frame may include a base frame, a pair of horizontal frames placed at the top and bottom of the base frame, and a pair of vertical frames placed at the sides of the base frame, each of the pair of horizontal frames and the pair of the vertical frames including a fastening hole, one vertical frame of the pair of vertical frames being equipped with a first fastening device fastened to the other vertical frame of another chromakey screen unit, and one horizontal frame of the pair of horizontal frames being equipped with a second fastening device fastened to the other horizontal frame of another chromakey screen unit.

The first fastening device may include a base plate fixed to the inner side of the vertical frame at the position where the fastening hole is formed, a first fastening rod extending through the base plate and the fastening hole, a rotating body connected rotatably around the circumference of the first fastening rod, and an elastic spring wrapping around the first fastening rod between the base plate and the rotating body.

The first fastening rod may be equipped with a fastening pin protruding in a width direction perpendicular to the longitudinal direction at the front end, and the fastening hole may be formed in a shape corresponding to the shape of the first fastening rod and the fastening pin.

The first fastening road of the first fastening device may be connected through the fastening hole of the vertical frame of the chromakey screen unit and fastening hole of the opposite vertical frame of another chromakey screen unit and rotates, causing the fastening pin to rotate and securely engage with the inner side of the opposite vertical frame of the other chromakey screen unit.

The chromakey screen system may further include an angle adjustment device mounted on the other vertical frame of the pair of vertical frames, the angle adjustment device comprises a connection hole being engaged with the fastening pin.

The angle adjustment device may include a housing having an interior space and one side fixable to the inner side of the opposite vertical frame, a bracket including a first body being inserted into or withdrawn from the interior space through an opening provided on the one side of the housing and a second body extending in a bent manner from one end of the first body, and a fixing pin inserted through an outer side connecting the one side and the other side of the housing to selectively secure the first body.

The interior space may be provided in a circular arc shape, and the housing may be provided with a guide hole of a circular shape connecting to the interior space on an upper surface and a fitting hole on the outer side into which the fixing pin is inserted.

The first body may be provided with a plurality of positioning recesses on the side in contact with the fixing pin and a guide protrusion moving along the guide hole on an upper surface.

The second body may be provided with the connection hole formed in a shape corresponding to the shape of the fastening pin, and while the first body protrudes outwardly through the other vertical frame, the second body is configured to be positioned on the outer side of the other vertical frame and securely engaged with the fastening pin extended through the one vertical frame of another chromakey screen unit.

The second fastening device may include a bracket fixed to the inner side of the horizontal frame at the position where the fastening hole is formed, and a second fastening road extending through the bracket and the fastening hole.

The horizontal frame placed on the top of the base frame may be provided with a binding protrusion protruding upward on the upper surface, and the horizontal frame placed on the bottom of the base frame may be provided with a hole having a structure interlocking with the binding protrusion.

The chromakey screen system may further comprises a flying kit, the flying kit comprises a connection frame connected to the horizontal frame at the upper part of the base frame, and a hanging hook provided on the upper surface of the connection frame.

The chromakey screen system may further include a support structure attached to the backside of the frame and casters provided at the bottom of the support structure.

### BRIEF DESCRIPTION OF THE SEVERAL VIEWS OF THE DRAWINGS

FIG. 1 is a schematic diagram illustrating a chromakey screen system according to an embodiment of the present invention;

FIG. 2 is a diagram illustrating a chromakey screen unit of the chromakey screen system;

FIG. 3 is a diagram illustrating a frame and a screen constituting the chromakey screen unit;

FIG. 4 is a diagram illustrating a frame and fastening devices constituting a flat-type chromakey screen unit;

FIG. 5 is a diagram illustrating a frame, fastening devices, and angle adjustment devices constituting a curved-type chromakey screen unit;

FIGS. 6A to 6C are a series of views illustrating a first fastening device in different directions;

FIGS. 7A to 7C are a series of side views illustrating the operation of a first fastening device;

FIGS. 8A and 8B are side views and plan views respectively illustrating the operation of a second fastening device;

FIG. 9 is a diagram illustrating an angle adjustment device;

FIGS. 10A and 10B are diagrams respectively illustrating a housing and bracket constituting an angle adjustment device;

FIG. 11 is a diagram illustrating the operation of an angle adjustment device;

FIGS. 12A to 12C are diagrams illustrating a series of states of an angle adjustment device adjusting the angle between chromakey screen units according to an embodiment;

FIG. 13 is a diagram illustrating the state where a flying kit is attached to a chromakey screen unit;

FIGS. 14 and 15 are diagrams illustrating a flying kit;

FIGS. 16 and 17 are diagrams illustrating a chromakey screen system installed in the air via a flying kit according to an embodiment; and

FIG. 18 is a diagram illustrating a support structure with casters, which is attached to the back of a chromakey screen unit.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DESCRIPTION OF SPECIFIC EMBODIMENTS OF THE INVENTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Hereinafter, embodiments of the present invention will be described in detail with reference to the accompanying drawings, and components which are the same or correspond to each other will be denoted by the same or corresponding reference numerals in all drawings, and redundant descriptions will be omitted.

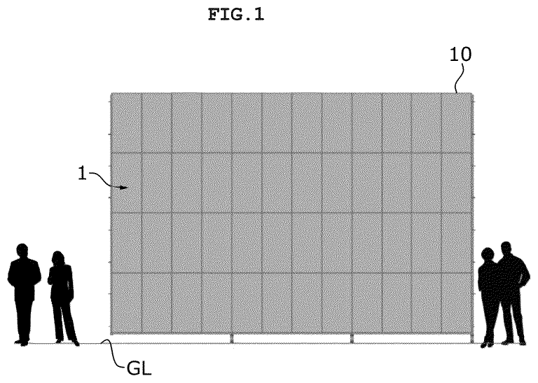

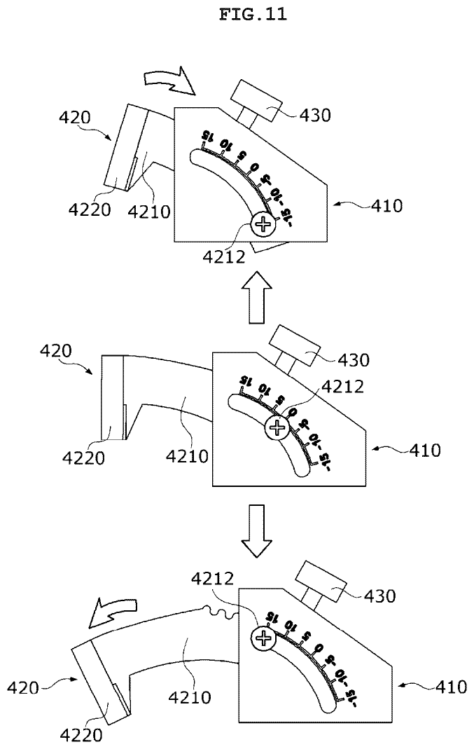

FIGS. 1 to 18 illustrate the configuration of the chromakey screen system and chromakey screen unit according to embodiments of the present invention.

With reference to the drawings, the chromakey screen system according to an embodiment of the present invention may be comprised of chromakey screen units 10 connected with each other.

In an embodiment, the chromakey screen unit 10 may include a frame 100, a screen 200 attached to the front of the frame 100, and fastening devices 300 mounted on the frame 100. In the state where the frames 100 of the chromakey screen units 10 are interconnected in a grid pattern via the fastening devices 300, the screens 200 of the chromakey screen units 10 abut along their edges, forming a single integrated screen 1.

The shape of the integrated screen 1 may be configured to vary according to the arrangement structure of the chromakey screen units 10 forming a grid pattern. By connecting the chromakey screen units 10 horizontally (left and right) or vertically (up and down), it is possible to create a unified integrated screen 1 of various shapes, expanding to the desired size both h vertically and horizontally. In addition, the integrated screen 1 may be transformed into various shapes, including curved shapes or wavy shapes, as well as flat shapes.

Hereinafter, a description is made of the chromakey screen unit 10 in more detail.

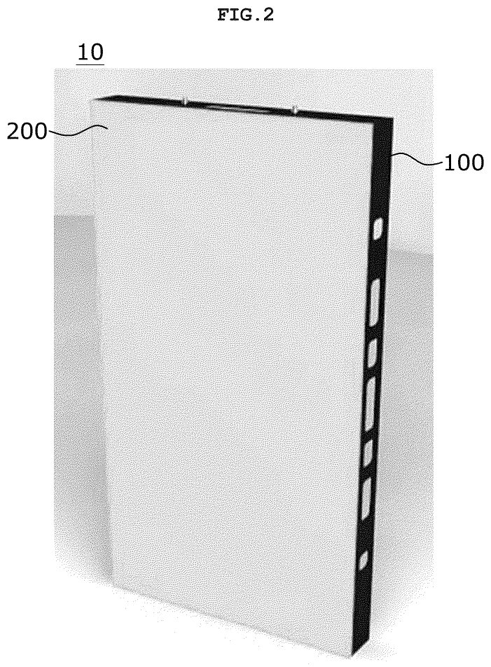

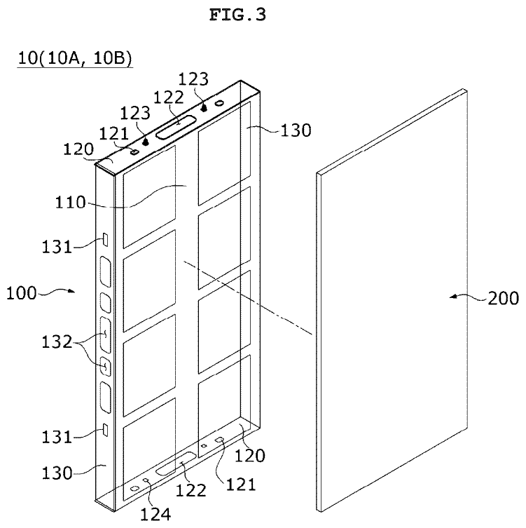

With reference to FIGS. 2 and 3, the chromakey screen unit 10 may include a frame 100, a screen 200, and a fastening device 300. According to an embodiment, the chromakey screen unit 10 may further include an angle adjustment device 400 and a flying kit 500.

The frame 100 may include a base frame 110, a pair of horizontal frames 120 arranged at the upper and lower parts of the base frame 110, and a pair of vertical frames 130 arranged at the sides of the base frame 110. That is, the structure may have an approximately rectangular shape where the horizontal frames 120 and vertical frames 130 surround the perimeter of the base frame 110.

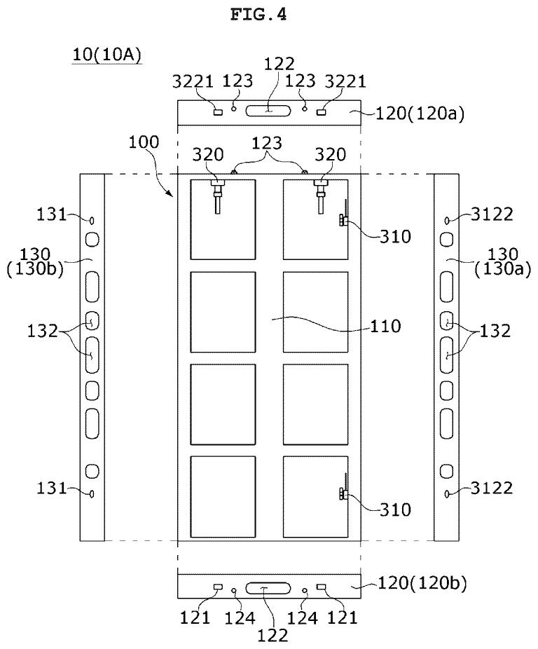

As shown in FIG. 4, the horizontal frames 120 may have a flat rectangular shape. A flat-type chromakey screen unit 10A may be equipped with horizontal frames 120 having a rectangular structure. In an embodiment, a flat-type chromakey screen unit 10A may implement an integrated screen 1 with a flat shape.

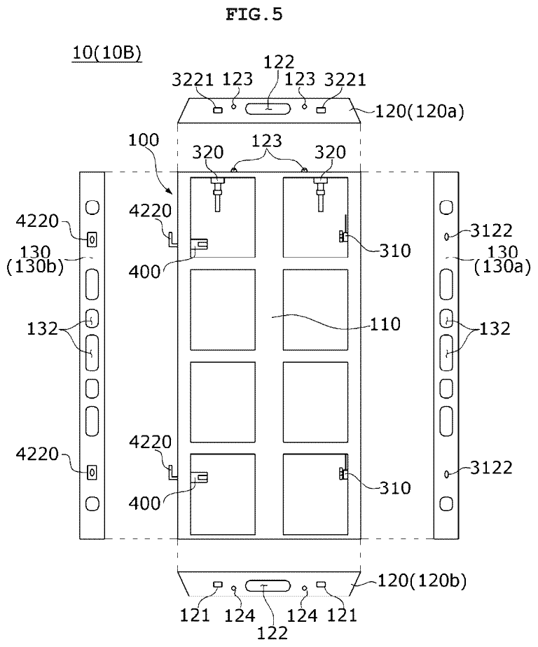

As shown in FIG. 5, the horizontal frames 120 may have a trapezoidal flat shape. A curved-type chromakey screen unit 10B may be equipped with horizontal frames 120 having a trapezoidal structure. The curved-type chromakey screen unit 10B may implement a integrated screen 1 with a non-flat shape, such as a curved shape or a wavy shape, rather than flat shape.

The horizontal frames 120 and vertical frames 130 may each have fastening holes 121 and 131 formed therein. Additionally, the horizontal frames 120 and vertical frames 130 may each have through-holes 122 and 132 formed therein. The through-holes 122 and 132 may serve as handles for workers to grip and manipulate the frame 100 by hand, as well as functioning as ventilation outlets for air passage.

The horizontal frame 120a positioned on the top of the base frame 110 may be equipped with binding protrusions 123 on the upper surface. The horizontal frame 120b positioned on the bottom of the base frame 110 may be equipped with holes 124 having a structure interlocking with the binding protrusions 123. The binding protrusions 123 and the holes 124 may serve the role of guiding the positions of the chromakey screen units 10 when being connected to each other, ensuring the chromakey screen units 10 are placed and fitted together correctly.

In an embodiment, the frame 100 may be made of a rigid material. For example, it may be made of metal but is not limited thereto.

The screen 200 may be configured to be attached to the front of the frame 100.

The screen 200 may have a roughly rectangular shape corresponding to the structure 100. Additionally, the screen 200 may be attached to cover the front of the frame 100.

In an embodiment, the screen 200 may be made of materials such as boards, plywood, and fabric. Additionally, the screen 200 may have a color, such as blue and green.

The fastening device 300 may include a first fastening device 310 and a second fastening device 320.

The first fastening device 310 may be configured to be mounted one of a pair of vertical frames 130, e.g., the vertical frame 130a, to be fastened to the opposite vertical frame 130b of another chromakey screen unit 10. That is, the first fastening device 310 mounted on one vertical frame 130a of the chromakey screen unit 10 may be fastened to the opposite vertical frame 130b of another chromakey screen unit 10, allowing a plurality of chromakey screen units 10 to be horizontally connected in a structure abutting each other.

The second fastening device 320 may be configured to be mounted on one of a pair of horizontal frames 120, e.g., the horizontal frame 120a, to be fastened to the opposite horizontal frame 120b of another chromakey screen unit 10. That is, the second fastening device 320 mounted on one horizontal frame 120a of the chromakey screen unit 10 may be fastened to the opposite horizontal frame 120b of another chromakey screen unit 10, allowing a plurality of chromakey screen units 10 to be vertically connected in a structure abutting each other. In an embodiment, one horizontal frame 120a may be positioned on the top of the base frame 110, while the opposite horizontal frame 120b may be positioned on the bottom of the base frame 110.

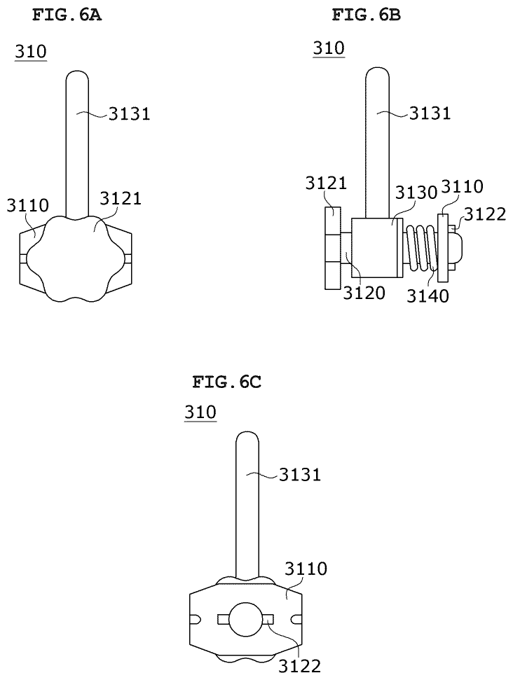

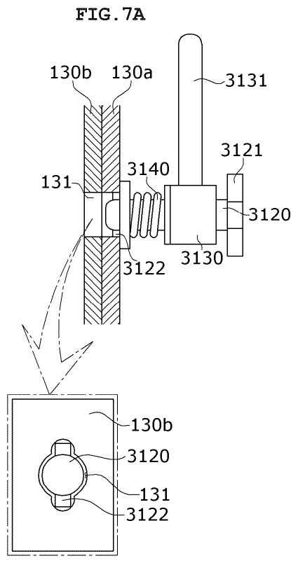

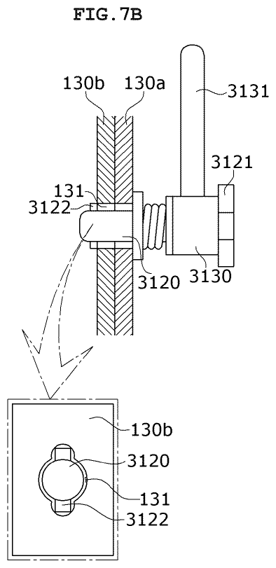

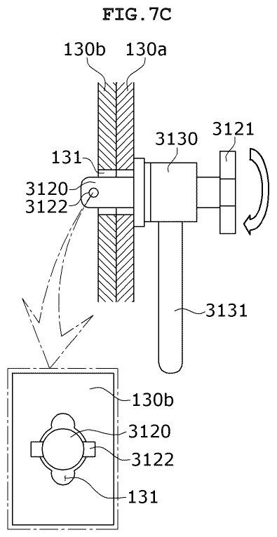

As shown in FIGS. 6A to 6C and 7A to 7C, the first fastening device 310 may include a base plate 3110, a first fastening rod 3120, a rotation body 3130, and an elastic spring 3140.

The base plate 3110 has a generally flat flange-like plate structure and may be secured to the inner side of the vertical frame 130 at a position where the fastening hole 131 is formed, via screw fastening.

The first fastening rod 3120 may have a rod-shaped structure extending along the length direction through the base plate 3110 and the fastening hole 131.

The first fastening rod 3120 may be equipped with a first handle 3121 at the rear end, allowing for a worker to grip and manipulate by hand. Accordingly, the worker may rotate the first fastening rod 3120 through the first handle 3121.

The first fastening rod 3120 may be equipped with a fastening pin 3122 protruding in the width direction perpendicular to the length direction at the front end. The fastening hole 131 may be formed in a shape corresponding to the shape of the fastening pin 3122 protruding from the first fastening rod 3120. For example, the fastening hole 131 may be formed in an elliptical or rectangular shape. Thus, with the fastening pin 3122 fitting into the fastening hole 131, the first fastening rod 3120 may extend through the fastening hole 131.

The rotation body 3130 may be rotatably connected to the periphery of the first fastening rod 3120. The rotation body 3130 is configured to rotate around the periphery of the first fastening rod 3120 and move back and forth along the first fastening rod 3120.

The rotation body 3130 may be equipped with a second handle 3131. The second handle 3131 may extend in a direction perpendicular to the first fastening rod 3120.

The elastic spring 3140 may be provided as a structure wrapping around the first fastening rod 3120 between the base plate 3110 and the rotation body 3130. When compressed by the rotation body 3130, the elastic spring 3140 may provide elastic force to restore the rotation body 3130 to its original position.

The first fastening device 310 may be configured such that, when the first fastening rod 3120 is connected through the fastening hole 131 of the vertical frame 130a of the chromakey screen unit 10 and the fastening hole 131 of the opposite vertical frame 130b of another chromakey screen unit 10, the first fastening rod 3120 rotates, causing the fastening pin 3122 to rotate and securely engage with the inner side of the opposite vertical frame 130b of the other chromakey screen unit 10.

That is, when two chromakey screen units 10 are arranged side by side with their sides abutting each other, the first fastening rod 3120 of the first fastening device 310 mounted on one vertical frame 130a of one chromakey screen unit 10 extends through and connects the one vertical frame 130a and the opposite vertical frame 130b of another chromakey screen unit 10 as a whole, allowing for engagement by rotating the first fastening rod 3120 to cause the fastening pin 3122 to misalign with the fastening hole 131 of the opposite vertical frame 130b. In this state, rotating the rotation body 3130 toward the base plate 3110 by turning the second handle 3131 allows the rotation body 3130 to interact with the fastening pin 3122 to securely fasten the vertical frame 130a and the other vertical frame 130b in a screw tightening manner.

Using the first fastening device 310, it is possible to connect a plurality of chromakey screen units 10 in a detachable manner along the horizontal direction.

The second fastening device 320 may include a support 3210 fixed to the inner side of the horizontal frame 120 at a position where the fastening hole 121 is formed, and a second fastening rod 3220 extending through the bracket 3210 and the fastening hole 121.

On the inner side of the support 3210, a tension spring (not shown) may be equipped to provide elastic force for restoring the second fastening rod 3220 to the original position when compressed by the second fastening rod 3220.

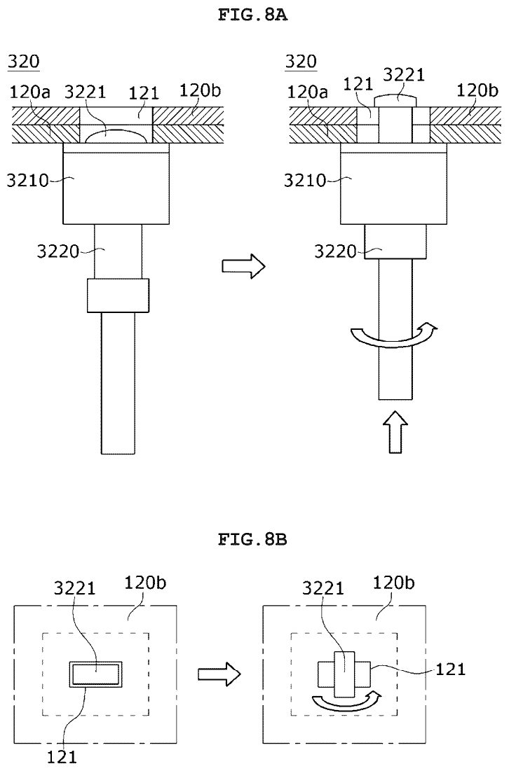

As shown in FIGS. 8A and 8B, the second fastening rod 3220 may be equipped with engagement protrusions 3221 extending perpendicular to the length direction on the end. The fastening hole 121 may be formed in a shape corresponding to the shape of the engagement protrusions 3221. For example, the fastening hole 121 may be formed in an elliptical or rectangular shape. Therefore, in the state where the engagement protrusion 3221 aligns with the fastening hole 121, the second fastening rod 3220 may be extended through the fastening hole 121.

When two chromakey screen units 10 are vertically arranged with their top and bottom surfaces abutting each other, the second fastening rod 3220 of the second fastening device 320 mounted on the upper horizontal frame 120a of the lower chromakey screen unit 10 extends through and connects the upper horizontal frame 120a and the lower horizontal frame 120b of the upper chromakey screen unit 10 as a whole, allowing for engagement by rotating the second fastening rod 3220 such that the engagement protrusion 3221 is positioned to prevent alignment with the fastening hole 121 of the lower horizontal frame 120b of the upper chromakey screen unit 10.

Using the second fastening devices 320, a plurality of chromakey screen units 10 may be vertically connected and detached.

The angle adjustment device 400 may be mounted on one of a pair of vertical frames 130. That is, the first fastening device 310 may be mounted on one vertical frame 130a, while the angle adjustment device 400 may be mounted on the other vertical frame 130b.

The angle adjustment device 400 may be configured to engage with the first fastening device 310 by providing a connecting hole 4221 that aligns with the fastening pin 3122 of the first fastening device 310.

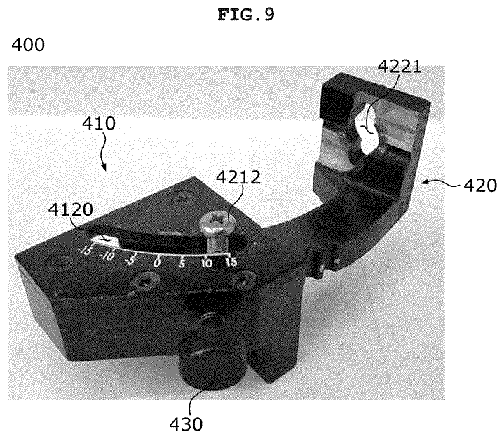

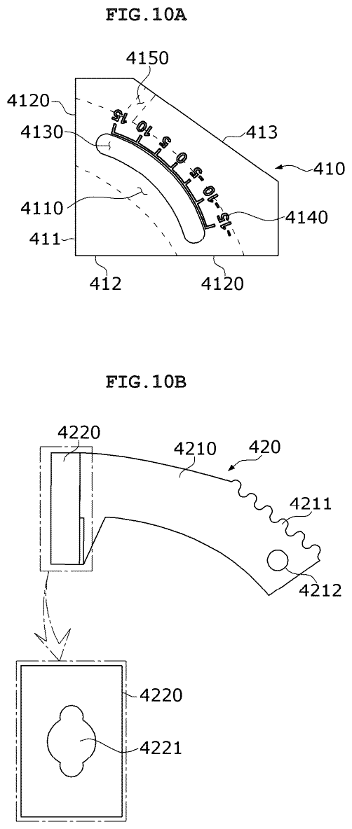

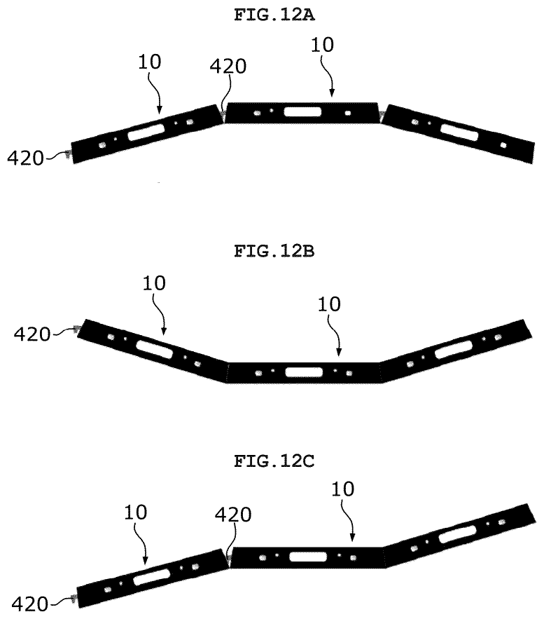

With reference to FIG. 9, FIGS. 10A and 10B, FIGS. 12A to 12C, the angle adjustment device 400 may include a housing 410, a bracket 420, and a fixing pin 430.

The housing 410 may have an interior space 4110 and one side 411 fixable to the inner side of the opposite vertical frame 130b. The interior space 4110 may be provided in a circular arc shape and opened to the outside through openings 4120 provided on one side 411 and another side 412 of the housing 410. While this embodiment illustrates the housing 410 with one side 411 and another side 412 forming a right angle, this is not exhaustive.

The housing 410 may be provided with guide holes 4130 of arc shape, which are connected to the interior space 4110 on the upper surface. The guide holes 4130 may be provided in a slotted structure extending in a curved manner along the arc shape of the interior space 4110. In addition, graduations 4140 indicating the angle may be marked on the upper surface of the housing 410 along the guide hole 4130. In this embodiment, the graduations 4140 may be marked at approximately 5° intervals around 0°, ranging from −15° to 15°.

The housing 410 may be provided with a fitting hole 4150 formed in the outer side 413 connecting the one side 411 and the other side 412, allowing for the insertion the fixing pin 430.

The bracket 420 may include a first body 4210 sliding within the interior space 4110 of the housing 410 and a second body 4220 extending in a bent manner from one end of the first body 4210.

The first body 4210 may be inserted into or withdrawn from the interior space 4110 through the opening 4120 provided on the one side 411 of the housing 410. In the state where one side 411 of the housing 410 is fixed to the vertical frame 130b, the opening 4120 may be connected to the fastening hole 131. Therefore, the first body 4210 may be extended through the fastening hole 131 to penetrate the vertical frame 130b. That is, the first body 4210 may be inserted into or withdrawn from the interior space 4110 of the housing 410 through the vertical frame 130b.

The first body 4210 may be equipped with a plurality of positioning recesses 4211 on the side facing the outer side 413 of the housing 410. Here, the side of the first body 4210 may correspond to the surface in contact with the fixing pin 430.

The first body 4210 may also be equipped with a guide protrusion 4212 arranged within the guide hole 4130 on the upper surface to move along the guide holes 4130. The guide protrusion 4212 may protrude upward through the guide hole 4130 onto the upper surface of the housing 410.

The guide protrusion 4212 may serve to guide the first body 4210 along a predetermined trajectory within the interior space 4110. The guide protrusion 4212 may indicate the angle between the one side 411 of the housing 410 attached to the vertical frame 130b and the second body 4220. That is, when the vertical frame 130b and the second body 4220 are parallel to each other, the guide protrusion 4212 may be positioned at the 0° graduation. When the first body 4210 is withdrawn and the second body 4220 is positioned at a 15° angle with the vertical frame 130b, the guide protrusion 4212 may be positioned at the 15° graduation.

The second body 4220 may be bent from the end of the first body 4210 to be parallel to the outer side of the vertical frame 130b. The second body 4220 may be equipped with a connection hole 4221 formed in a shape corresponding to the cross-sectional shape of the first fastening rod 3120 and the shape of the fastening pin 3122 provided on the first fastening rod 3120.

In a state where the first body 4210 protrudes outward through the opposite vertical frame 130b, the second body 4220 may be positioned on the outer side of the opposite vertical frame 130b and engage with the fastening pin 3122 of the extended first fastening rod 3120, which penetrates through the vertical frame 130a of another chromakey screen unit 10, enabling engagement fastening.

The fixing pin 430 fits into the fitting hole 4150 formed on the outer side 413 of the housing 410 to selectively secure the first body 4210 through rotation. In detail, the fixing pin 430 may be inserted into one of the positioning recesses 4211 formed on the side of the first body 4210 by advancing through rotation. Accordingly, the first body 4210 becomes immobilized and fixed due to the interference of the fixing pin 430. By rotating the fixing pin 430 in the opposite direction, the fixing pin 430 retracts to come out of the position adjustment notch 4211, and the first body 4210 becomes movable.

With the angle adjustment device 400 mounted on the chromakey screen unit 10, the chromakey screen unit 10 may be connected to another chromakey screen unit 10 using a structure where the bracket 420 of the angle adjustment device 400 interlocks with the first fastening device 310 of the other chromakey screen unit 10. The sliding movement of the bracket 420 enables adjustment of the angle between horizontally connected chromakey screen units 10.

As shown in FIG. 12, the chromakey screen units 10 connected horizontally via the angle adjustment device 400 may be arranged in a curved form with a predetermined angle. This allows for the implementation of an integrated screen 1 with various shapes such as concave curved, convex curved, or undulating surfaces.

In this embodiment, although the angle adjustment device 400 is illustrated as being mounted on the curved type chromakey screen unit 10B among the chromakey screen units 10, this is not exhaustive. The angle adjustment device 400 may also be mounted on the flat type chromakey screen unit 10A as needed.

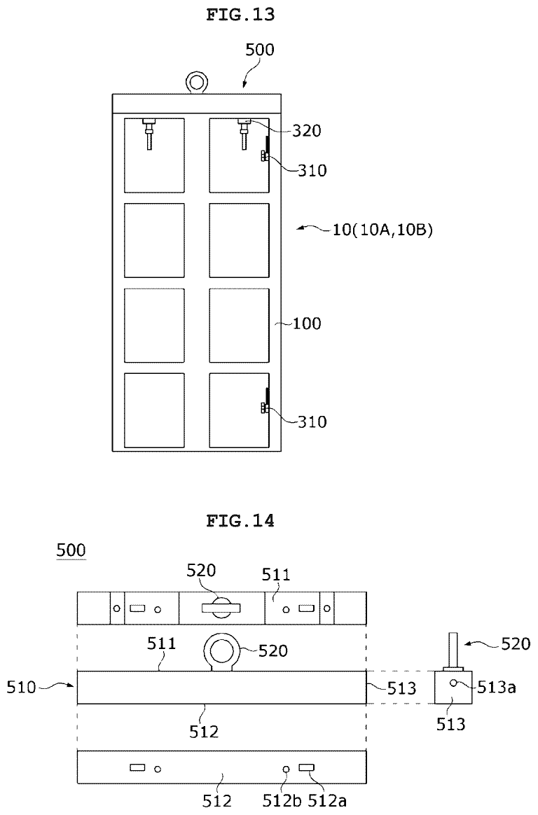

As shown in FIG. 13, the flying kit 500 may be configured to be attached to the top of the frame 100, allowing the chromakey screen unit 10 to be lifted from the floor and placed in a suspended state in the air.

With reference to FIGS. 13 to 15, the flying kit 500 may include a connection frame 510 and a hanging hook 520.

The connection frame 510 may be attached to the upper part of the base frame 110 onto the horizontal frame 120.

The connection frame 510 may have a roughly rectangular cross-sectional hollow tube structure, and on the underside 512 that interfaces with the horizontal frame 120 among its four sides, fastening holes 512a may be formed to engage with the engagement protrusions 3221 of the second fastening rod 3220 of the second fastening device 320. Furthermore, holes 512b may be formed to receive the binding protrusions 123 attached to the horizontal frame 120.

A binding hole 513 may be formed on each of the left and right sides 513 of the connection frame 510. The connection frame 510 may be mutually coupled with the sides of adjacent connection frames 510 through bolts (not shown) inserted into the binding holes 513a.

The hanging hook 520 may be provided on the upper surface 511 of the connection frame 510. The hanging hook 520 may have a roughly ring-shaped structure and may be positioned at the center of the upper surface 511.

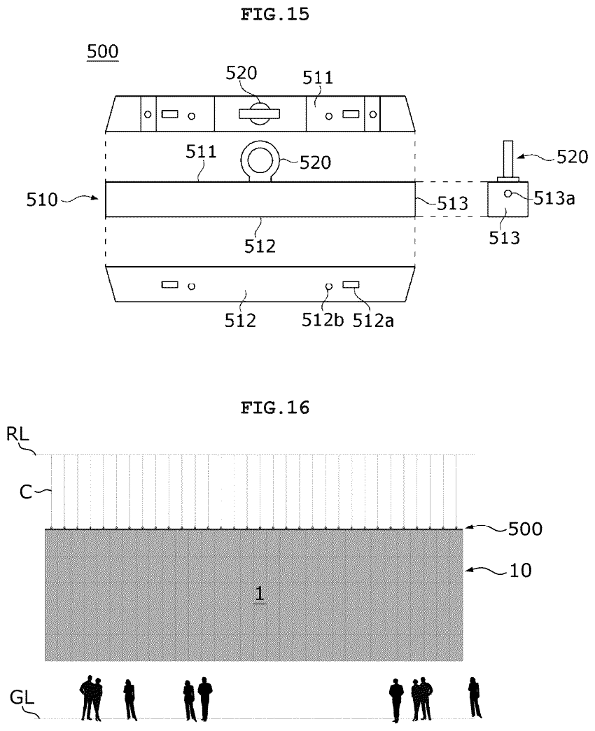

As shown in FIGS. 14 and 15, the bottom surface 512 and upper surface 511 of the connection frame 510 may have a shape corresponding to the planar shape of the horizontal frame 120. That is, it may have a rectangular structure corresponding to the flat-type chromakey screen unit 10A and a trapezoidal structure corresponding to the curved-type chromakey screen unit 10B.

In an embodiment, the connection frame 510 and the hanging hook 520 may be made of a rigid material, such as metal, but this is not exhaustive.

The chromakey screen system may be installed in a suspended state using the flying kit 500.

As shown in FIG. 16, the chromakey screen unit 10, with the cable C attached to the hanging hook 520, may be suspended from the ceiling RL and placed in midair. By adjusting the length of cable C, the chromakey screen unit 10 may be positioned at variable heights relative to the floor GL.

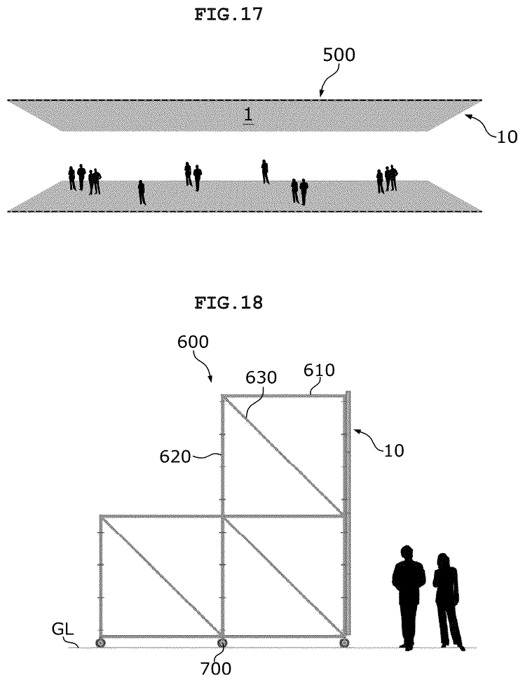

As shown in FIG. 17, with the aid of the flying kit 500, the chromakey screen unit can be suspended in the air to establish an integrated screen 1 covering the ceiling

With reference to FIG. 18, the chromakey screen system may further include a support structure 600 and casters 700 to facilitate the mobility of the installed chromakey screen system, which has implemented the integrated screen 1.

The support structure 600 may be attached to the backside of the frames 100 of each chromakey screen unit 10. In an embodiment, the support structure 600 may include horizontal bars 610 and vertical bars 620 intersecting orthogonally and diagonal bars 630 connecting the junctions of the horizontal bars 610 and vertical bars 620 diagonally.

The casters 700 may be provided at the bottom of the support structures 600.

With this configuration, the chromakey screen system may be moved and positioned according to the on-site requirements while in the installed state.

As described above, the chromakey screen system according to this embodiment is assembled by connecting individual chromakey screen units 10 in a grid pattern, allowing for variability to suit the desired shooting radius. Therefore, there is a high degree of design flexibility, as the integrated screen 1 serving as the shooting background can be freely transformed into various sizes and shapes.

Additionally, unlike disposable products made from conventional fabric and wood materials, this system offers the advantage of being semi-permanent and generating no industrial waste.

In particular, it is expected to establish itself as a global standard capable of being used not only in domestic but also in various foreign shooting locations, as it can address the issues faced in domestic and international video production sites caused by the limitations of conventional chromakey systems made of materials such as fabric and wood.

According to an embodiment of the present invention, the chromakey screen system offers the advantages of semi-permanent use, eliminates the generation of industrial waste, and provides flexibility to adjust according to the desired shooting radius.

The effects of the present invention are not limited to the aforesaid, and other effects not described herein with will be clearly understood by those skilled in the art from the descriptions below.

While the foregoing description has focused on specific embodiments of the present invention, it should be understood that various modifications and changes can be made by those skilled in the art without departing from the spirit and scope of the invention as defined in the appended claims. Furthermore, any distinctions arising from such modifications and changes should be understood to fall within the scope of the present invention as delineated in the appended claims.

What is claimed is:

1. A chromakey screen system comprising:
a plurality of chromakey screen units, each comprising a frame, a screen attached to the front of the frame, and fastening devices mounted on the frame,
wherein the frames of the chromakey screen units are interconnected in a grid pattern via the fastening devices, with the screens of the chromakey screen units abutting along the edges to form a single integrated screen, and the shape of the integrated screen is configured to be variable according to the arrangement structure of the chromakey screen units forming the grid pattern.

2. The chromakey screen system of claim 1, wherein the frame comprises a base frame, a pair of horizontal frames placed at the top and bottom of the base frame, and a pair of vertical frames placed at the sides of the base frame, each of the pair of horizontal frames and the pair of the vertical frames comprising a fastening hole, one vertical frame of the pair of vertical frames being equipped with a first fastening device fastened to the other vertical frame of another chromakey screen unit, and one horizontal frame of the pair of horizontal frames being equipped with a second fastening device fastened to the other horizontal frame of another chromakey screen unit.

3. The chromakey screen system of claim 2, wherein the first fastening device comprises a base plate fixed to the inner side of the vertical frame at the position where the fastening hole is formed, a first fastening rod extending through the base plate and the fastening hole, a rotating body connected rotatably around the circumference of the first fastening rod, and an elastic spring wrapping around the first fastening rod between the base plate and the rotating body.

4. The chromakey screen system of claim 3, wherein the first fastening rod is equipped with a fastening pin protruding in a width direction perpendicular to the longitudinal direction at the front end, and the fastening hole is formed in a shape corresponding to the shape of the first fastening rod and the fastening pin.

5. The chromakey screen system of claim 4, wherein the first fastening road of the first fastening device is connected through the fastening hole of the vertical frame of the chromakey screen unit and fastening hole of the opposite vertical frame of another chromakey screen unit and rotates, causing the fastening pin to rotate and securely engage with the inner side of the opposite vertical frame of the other chromakey screen unit.

6. The chromakey screen system of claim 4, further comprising an angle adjustment device mounted on the other vertical frame of the pair of vertical frames, the angle adjustment device comprises a connection hole being engaged with the fastening pin.

7. The chromakey screen system of claim 6, wherein the angle adjustment device comprises a housing having an interior space and one side fixable to the inner side of the other vertical frame, a bracket comprising a first body being inserted into or withdrawn from the interior space through an opening provided on the one side of the housing and a second body extending in a bent manner from one end of the first body, and a fixing pin inserted through an outer side connecting the one side and the other side of the housing to selectively secure the first body.

8. The chromakey screen system of claim 7, wherein the interior space is provided in a circular arc shape, and the housing is provided with a guide hole of a circular shape connecting to the interior space on an upper surface and a fitting hole on the outer side into which the fixing pin is inserted.

9. The chromakey screen system of claim 8, wherein the first body is provided with a plurality of positioning recesses on the side in contact with the fixing pin and a guide protrusion moving along the guide hole on an upper surface.

10. The chromakey screen system of claim 7, wherein the second body is provided with the connection hole formed in a shape corresponding to the shape of the fastening pin, and while the first body protrudes outwardly through the other vertical frame, the second body is configured to be positioned on the outer side of the other vertical frame and securely engaged with the fastening pin extended through the one vertical frame of another chromakey screen unit.

11. The chromakey screen system of claim 2, wherein the second fastening device comprises a bracket fixed to the inner side of the horizontal frame at the position where the fastening hole is formed, and a second fastening road extending through the bracket and the fastening hole.

12. The chromakey screen system of claim 2, wherein the horizontal frame placed on the top of the base frame is provided with a binding protrusion protruding upward on the upper surface, and the horizontal frame placed on the bottom of the base frame is provided with a hole having a structure interlocking with the binding protrusion.

13. The chromakey screen system of claim 2, further comprising a flying kit, the flying kit comprises a connection frame connected to the horizontal frame at the upper part of the base frame, and a hanging hook provided on the upper surface of the connection frame.

14. The chromakey screen system of claim 1, further comprising a support structure attached to the backside of the frame and casters provided at the bottom of the support structure.
